(19) United States
(12) Patent Application Publication
(10) Pub. No.: US 2019/0039472 A1
(43) Pub. Date: Feb. 7, 2019

(54) Methods and Apparatus for Drive to Position Docking Station for Charging of Electric Vehicles

(71) Applicant: Christopher John Eiras, Atlantic Beach, FL (US)

(72) Inventor: Christopher John Eiras, Atlantic Beach, FL (US)

(21) Appl. No.: 16/052,599

(22) Filed: Aug. 1, 2018

Related U.S. Application Data
(60) Provisional application No. 62/540,799, filed on Aug. 3, 2017.

(51) Int. Cl. B60L 11/18; H02J 7/00

(52) U.S. Cl. CPC B60L 11/1833; H02J 7/0027; B60L 11/184; B60L 11/1829; B60L 11/1818

(57) ABSTRACT

A method of providing electrical energy to a battery-powered vehicle through the use of a drive to position charging system wherein the vehicle utilizes a battery as a power source to propel a traction motor or other such device. The method includes electrically coupling an external source of electrical energy to said electric vehicle via transmission of energy based upon positioning said vehicle in proximity of said external source of energy, thus providing electrical energy flow to a vehicle battery without the need to manually connect or couple a power source during a charging period, while controlling electrical energy flow to said vehicle during a charging period.

### CROSS-REFERENCE TO RELATED APPLICATION

This application claims priority to U.S. Provisional Patent Application Ser. No. 62/540,799 entitled Methods and Apparatus for Drive to Position Docking Station for Charging of Electric Vehicles and filed on Aug. 3, 2017, which is incorporated herein by reference.

### BACKGROUND

This invention relates generally to the use of electrical vehicles and more particularly to a drive into position battery charge system for docking of an electrical vehicle.

Electric vehicles typically include a battery, a recuperative energy braking system, a motor controller, and at least one propulsive device, (generally a traction motor) controlled by a microprocessor and/or computer software. The various components are interconnected using a plurality of wires which may be assembled into a complex bundle, be a wiring harness, installed in the electric vehicle.

In at least three separate known Electric Vehicle (EV) design and manufacturing processes, the charging system for these vehicles requires that the user manually plug an electrically charged cable into the side of the vehicle when the vehicle is not in use. Other patented processes propose the use of lasers and other visual guides to properly position the EV in order to facilitate manually plugging in the unit more efficiently; however what is proposed herein is that no manual connection be performed by the user of the EV. All other known direct methods for charging of the EV require the user to exit the vehicle and plug the vehicle in to a wired power source or perform some other manual task related thereto for every charging period.

### SUMMARY OF THE PRESENT DISCLOSURE

A method of the present disclosure is providing and controlling electrical energy to a battery-powered vehicle by positioning the vehicle in the proximity of the source of power wherein the vehicle includes a battery and a form of propulsion such as traction motor. The method comprises conveying an external source of electrical energy to, an electrical connector for vehicle battery charging that allows the electric vehicle to position in the proximity of the charger which would automatically couple with the electric vehicle, thus controlling electrical energy flow to the vehicle battery during a charging period based upon its position in proximity of the charging station.

### BRIEF DESCRIPTION OF THE DRAWINGS

FIG. 1 is a side view of an exemplary system for charging an electric vehicle positioned within proximity to a charging device in accordance with an embodiment of the present disclosure.

### DETAILED DESCRIPTION

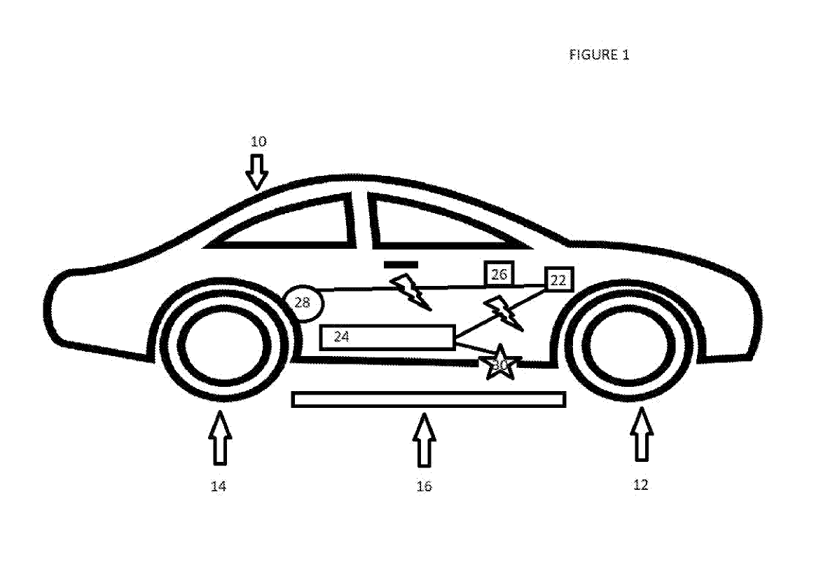

FIG. 1 is an exemplary embodiment of a system for charging an electric vehicle 10. The electric vehicle (EV) 10 may be, for example, a passenger car, but the vehicle could also be any number of types, of electric vehicles, such as a golf cart, fork lift, construction vehicle, motorcycle, powered bicycle, powered tricycle, passenger bus, cargo transport and the like.

The EV 10 includes at least one or a plurality of front wheels 12, and at least one or a plurality of rear wheels 14. In the exemplary embodiment, the EV 10 includes two front wheels 12 and two rear wheels 14.

The EV 10 also comprises a microcontroller system 22 and at least one battery 24 that is electrically connected to the microcontroller system 22 to facilitate providing electrical energy to drive EV 10. A switch 26 is electrically coupled to the microcontroller s_{y}stem 22, and permits power to be supplied from the battery 24 to at ;.least one traction motor or other drive device 28. A forward/reverse switch can be integrated into the switch 26 to the vehicle 10 to proceed in either a forward or a reverse direction.

In use, a driver or autonomous driving system (not shown) engages the microcontroller system 22 to select either a forward or reverse direction of motion for the EV 10 to cause the EV 10 to be positioned within proximity to a charging device 16. In the embodiment shown, the EV 10 is positioned directly aver the charging device 16. However, other positions of the charging device and the EV 10 may be used in other embodiments.

During a charging period, a power source (not shown) provides electricity to the charging device 16. The charging device 16 is electrically coupled to a power receptacle>30 to supply charging power to the battery 24. The device 16 may convey power to the power source connector 30 via a magnetic, electric or mechanical coupler, through actively maneuvered for inductive charging, or via any other preferred method of providing external power to the battery 24 now in use or that may be invented in the future. Although the embodiment of FIG. 1 shows the EV 10 positioned over the charging device 16 so that it may couple with the power source receptacle 30, the charging device 16 could be located above, in front, on either side r behind the EV 10 so long as the power source receptacle is positioned to facilitate a proper connection with said charging device.

In the embodiment depicted, the EV 10 is aligned above the device 16 in order to facilitate the power receptacle 30 to connect properly with the device 16. When EV 10 is successfully coupled with the device 16 an audible or visual alert may be utilized but is not necessary.

Microcontrollers 22 inside the EV 10 sense the power source connection through the power source connection to 30. Microcontrollers 22 then execute software, hardware, firmware or any combination thereof to control the charge of the battery 24 at a predetermined rate and duration based on battery discharge and use since the last charging period. Microcontrollers 22 also disable the motor controller functionality of the EV 10 to prevent motor operation during a charging period without an override of the EV operator. When microcontroller 22 complete execution, microcontroller 22 may end the charging period and may sound an audible or visual alert. Microcontroller 22 senses when the power source is removed through the power receptacle 30.

The above-described method for charging the EV 10 is cost-effective and highly reliable for consistent battery charging, by eliminating the need for the driver to manually plug in the EV 10 at each charging period and to avoid the potential for the driver to forget to plug in the EV 10 after use. Specifically, the functionality of a drive to dock charging system as the preferred method for battery charging facilitates a reduction of a number of manually dispatched components used, a number of cumbersome external wires and connection and facilitate simplifying charging and maintenance of the EV 10. As a result, the methods and apparatus described herein facilitate reducing electric vehicle maintenance costs while facilitating better EV reliability in cost-effective and efficient manner.

While the disclosure has been described in terms of various specific embodiments, those skilled in the art will recognize that the disclosure can be practiced with modification within the spirit and scope of the claims.

What is claimed is:

1. A method of providing electrical energy to a battery-powered electrical vehicle, the method comprising:
driving the electrical vehicle in proximity of a charging device;
coupling an external source of electrical energy to said electric vehicle;
transmitting energy to a vehicle battery of the electrical vehicle based upon positioning said electrical vehicle in proximity of the charging device;
providing electrical energy flow to the vehicle battery either magnetically, electronically or mechanically without the need to for the operator of said EV to manually couple a power source to the electrical vehicle during a charging period; and
controlling an electrical energy flow to said electrical vehicle during the charging period.

2. The method of claim 1, wherein coupling the power source to the vehicle is accomplished by electrically, magnetically, or mechanically coupling the external source of;electrical energy to the electrical vehicle via the charging device when the electrical vehicle is driven within proximity to the charging device so that a microcontroller electrically couples said external source of electrical energy from an external battery charger to said electrical vehicle.

3. The method of claim 2, wherein said electrically coupling to the external source of electrical energy comprises electrically coupling a signal path between the microcontroller and vehicle battery charge controller and the battery charger.

4. The method of claim 1, wherein controlling electrical energy flow to the vehicle battery comprises regulating at least one of a voltage output and a current output of the source of electrical energy using the integrated vehicle battery charge controller.

5. The method of claim 4, wherein regulating at least one of a voltage output and a current output of the source of electrical energy comprises regulating at least one of a voltage output and a current output of the source of electrical energy based on at least one of a battery state of charge and a predetermined charging program.

6. The method of claim 1, wherein the vehicle further comprises a microcontroller, further comprising operating by the microcontroller to control said disable said battery charge, and to control said battery charge.

7. The method of claim 6, wherein a battery charge controller comprises a charging current sensor.

8. The method of claim 7, further comprising determining, by said microcontroller, a state of charge of said battery from a battery discharge history of said battery.

9. The method of claim 8, further comprising controlling, by the microprocessor, said battery change controller to optimize a charging rate and duration based on the state of charge of said battery.
